(19) United States
(12) Patent Application Publication
(10) Pub. No.: US 2015/0271030 A1
(43) Pub. Date: Sep. 24, 2015

(54) METHODS AND SYSTEMS FOR DETECTION OF DATA ANOMALIES

(71) Applicant: VMware, Inc., Palo Alto, CA (US)

(72) Inventors: Al Yaros, Herzliya (IL); Eyal Cohen, Herzilya (IL); Evgeny Etkin, Herzliya (IL); Asaf Abramovitz, Herzliya (IL)

(73) Assignee: VMware, Inc., Palo Alto, CA (US)

(21) Appl. No.: 14/218,544

(22) Filed: Mar. 18, 2014

(51) Int. Cl. H04L 12/26; G06Q 10/00

(52) U.S. Cl. CPC H04L 43/04; G06Q 10/00; H04L 43/06

(57) ABSTRACT

The disclosure presents computational methods and systems for detecting and correcting, or deleting, data anomalies in data generated by information technology business management (“ITBM”) systems. In one aspect, a method receives a record of data generated by an ITBM system. The record of data includes data types and associated numerical values recorded over a number of time periods. The method detects one or more data anomalies in the record of data based on the numerical values of the data types in the time periods and reports a set of the one or more data anomalies to a user. The method also enables a user to correct the data anomalies in the recorded data based on the user's decision to selectively correct or delete each of the data anomalies.

### TECHNICAL FIELD

The present disclosure is directed to computational methods and systems for detecting and correcting, or deleting, anomalous data generated by information technology business management systems.

### BACKGROUND

In recent years, the number of enterprises purchasing information technology (“IT”) services from IT service providers has steadily increased. For example, a large number of enterprises purchase cloud computing services from IT service providers, because cloud computing enables enterprises to cut costs and decrease time to market while eliminating a heavy investment in IT and operating expenses. Many of the IT services purchased by enterprises are network-based services that appear to a user as real server hardware, but, in fact, are virtual machines (“VMs”) simulated by software running on one or more real computers. The VMs are not bound physical resources. Instead, VMs are virtual resources that may be moved around and scaled up or down as needed without affecting the user's experience. For example, an IT service provider allocates resources of a data center to satisfy high-demand periods for an enterprise's software may reallocate these same resources at other times when demand decreases. VMs enable IT service providers to maximize use of resources and lower the costs of IT services purchased by enterprises.

In order to more efficiently and effectively manage cost of IT services, IT service providers try to determine how much each service provided to an enterprise actually cost the provider. As a result, IT service providers must consider as many cost drivers as can possibly be monitored in order to accurately assess the cost of IT services. Accurately assessing the cost of IT services is typically handled by IT management software and systems that enable IT service providers to model and track the total cost of delivering and maintaining the IT services they provide to enterprises. IT cost transparency solutions integrate financial information such as labor, software licensing costs, hardware acquisition and depreciation, data center facilities charges, from general ledger systems and combines that with operational data from monitoring, asset management, and project portfolio management systems to provide a single, integrated view of IT costs by service, department, general ledger line item and project. Costs, budgets, performance metrics and changes to data points are tracked over time in order to identify trends in the data and the impact of changes to underlying cost drivers so that managers are better able to address cost drivers responsible for increasing IT costs and improve planning. However, the data collected and used to monitor cost drivers may be very large and contain data anomalies that affect the cost assessment of IT services. IT service providers seek methods and systems that can detect anomalies in the data tracked to assess IT costs and warn IT financial controllers of the anomalies and allow the anomalies to be corrected.

### SUMMARY

This disclosure presents computational methods and systems for detecting and correcting, or deleting, data anomalies in data generated to assess IT service cost by information technology business management (“ITBM”) systems. In one aspect, a computational method receives a record of data generated by an ITBM system. The record of data includes data types and associated numerical values recorded over a number of time periods. The method detects one or more data anomalies in the data and reports the data anomalies to a user. The method also enables a user to correct the data anomalies based on a user's decision to selectively correct or delete each of the data anomalies.

### DESCRIPTION OF THE DRAWINGS

FIG. 1 shows an example of an enterprise that receives information technology (“IT”) services from an IT service provider.

FIG. 2 shows an example of a generalized computer system that executes methods for determining cost outliers.

FIG. 3 shows an example of data flow in an information technology (“IT”) business management system.

FIG. 4 shows an example format of a record created in an adaptor/operator data flow of an IT business management system.

FIG. 5 shows an example record of email accounts used by an enterprise.

FIG. 6 shows an example of a bill of IT that displays an itemized list of cost of IT services.

FIG. 7 shows three example implementations of anomaly operators incorporated into an example adaptor/operator flow shown in FIG. 3.

FIGS. 8A-8C show an example of cost-outlier detection for a set of points.

FIG. 9 shows a flow-control diagram of an example anomaly operator.

FIG. 10 shows a flow-control diagram of a routine “find data anomalies” called in block 902 of FIG. 9.

FIG. 11 shows a flow-control diagram for a routine “outlier detection” called in block 1003 of FIG. 10.

FIG. 12 shows a flow-control diagram for a routine “comet data” called in block 906 of FIG. 9.

### DETAILED DESCRIPTION

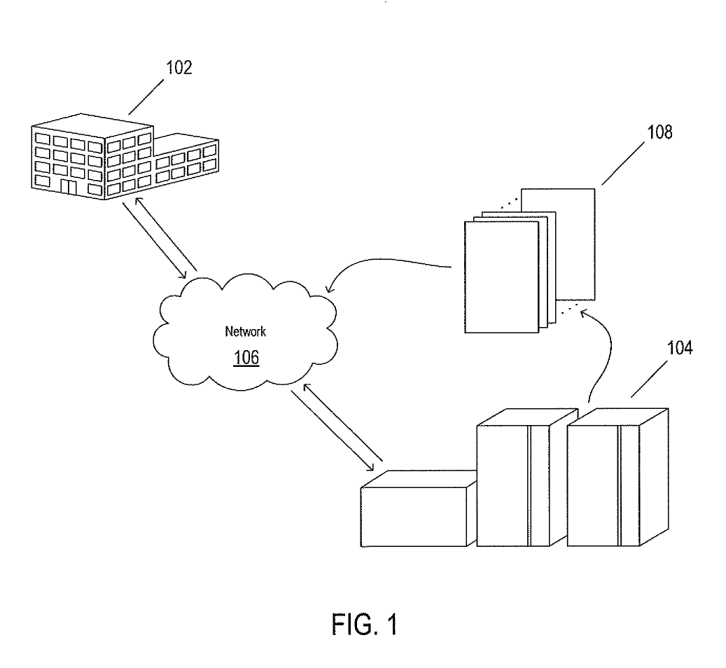

This disclosure presents computational methods and systems for detecting anomalous data in data generated in the course of tracking various information technology (“IT”) services. FIG. 1 shows an example of an enterprise 102 that receives IT services from an IT service provider 104. The enterprise 102 may be a business, an individual, a government agency, or any non-profit or for-profit organization. The IT service provider 104 maintains an infrastructure of computers, servers, data-storage devices, telecommunications, an internal network, virtual machines (“VMs”), virtual servers (“VSs”), email, and numerous other data processing and data-storage services. The enterprise 102 purchase IT services from the IT service provider 104 and accesses the services via a network 106, such as the Internet. For example, the IT service provider 104 may provide hosting services for one or more applications used by the enterprise 102. The IT service provider 104 may also provide private and public cloud computing services. For example, the IT service provider 104 may maintain a cloud infrastructure accessed solely by the enterprise 102, or the provider 104 may maintain a cloud infrastructure accessed by users of services offered by the enterprise 102 over the network 106.

The IT service provider 104 uses an IT business management (“ITBM”) system to generate a record 108 of data extracted from one or more data sources maintained by the IT service provider. The ITBM system uses adaptors to fetch data from data sources and uses data-management operators to perform various selected operations on the data in order to monitor and determine the cost of using IT services, as described in greater detail below. For example, typical data-management operators perform data manipulations, such as filtering, aggregating, joining and correlating. The disclosure describes ITBM systems that include one or more anomaly operators that may be placed anywhere within an adaptor/operator flow of the ITBM system in order to detect anomalies in the data generated in flow and correct, or delete, the anomalies from the data.

It should be noted at the onset that the data and the anomaly operators described below are not, in any sense, abstract or intangible. Instead, the data is necessarily digitally encoded and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems on electronically or magnetically stored data, with the results of the data processing and data analysis digitally encoded and stored in one or more tangible, physical, data-storage devices and media.

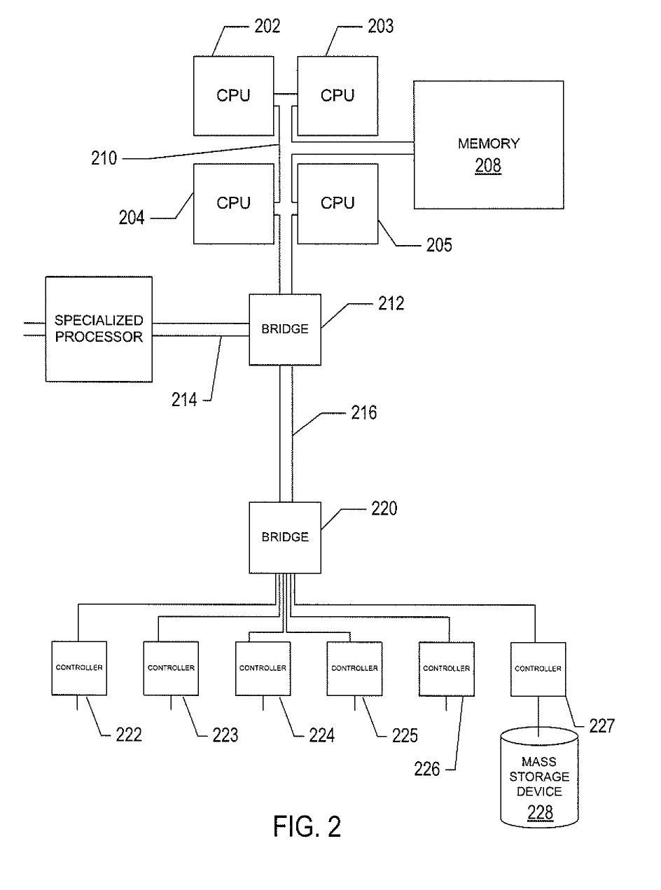

FIG. 2 shows an example of a generalized computer system that executes efficient methods for detecting cost outliers and therefore represents a data-processing system. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 202-205, one or more electronic memories 208 interconnected with the CPUs by a CPU/memory-subsystem bus 210 or multiple busses, a first bridge 212 that interconnects the CPU/memory-subsystem bus 210 with additional busses 214 and 216, or other types of high-speed interconnection media, including multiple, high-speed serial interconnects. The busses or serial interconnections, in turn, connect the CPUs and memory with specialized processors, such as a graphics processor 218, and with one or more additional bridges 220, which are interconnected with high-speed serial links or with multiple controllers 222-227, such as controller 227, that provide access to various different types of computer-readable media, such as computer-readable medium 228, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 228 is a data-storage device, including electronic memory, optical or magnetic disk drive, USB drive, flash memory and other such data-storage device. The computer-readable medium 228 can be used to store machine-readable instructions that encode the computational methods described below and can be used to store encoded data, during store operations, and from which encoded data can be retrieved, during read operations, by computer systems, data-storage systems, and peripheral devices.

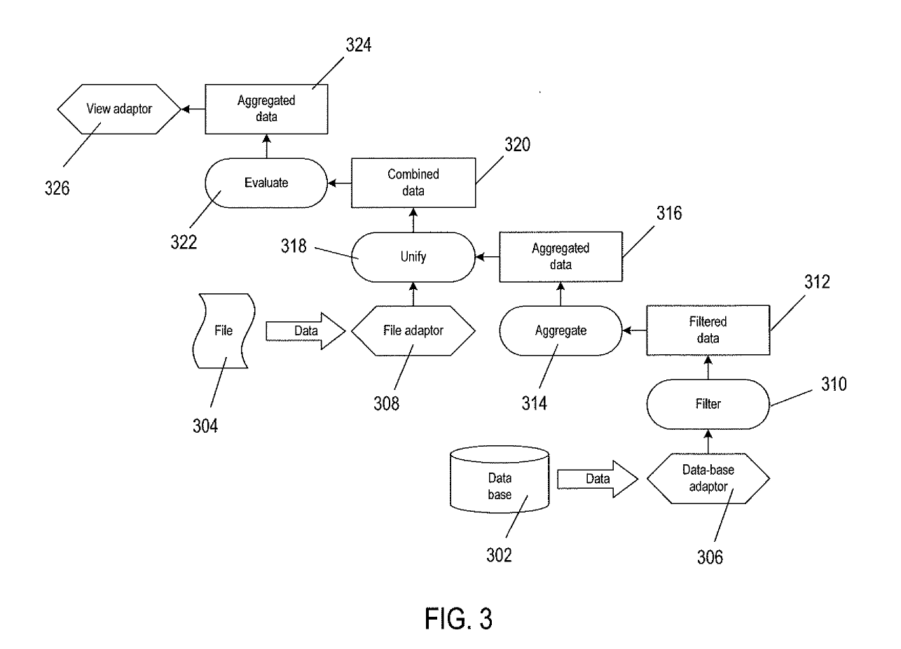

FIG. 3 shows an example of data flow in an ITBM system. A data flow is a series of hierarchically selected adaptors and operators. The adaptors fetch data from data sources and the data-management operators perform user defined manipulations and arrangements of the data. Each data-management operator performs a specific data operation on the data input to the data-management and stores the data in one or more data-storage devices. The order and type of data-management operators and adaptors are selected for an adaptor/operator flow by the ITBM system designer or user to generate a desired record of data. In the example of FIG. 3, a data base 302 and a text file 304 are two examples of data sources. A data-base adaptor 306 fetches data from the data base 302 and stores the data in a data-base record, such as a table, within the ITBM system. The data-base record may then be used as input for any data-management operator. The file adaptor 304 fetches data from the text file 304 and also stores the data in a data-base record, such as a table, within the ITBM system. In general, adaptors may be scheduled to periodically fetch data from data sources, such as on an hourly, daily, or monthly basis. The data-management operators are a filter operator 310, an aggregate operator 314, a unify operator 318, and a evaluate operator 322. The filter operator 310 uses a selection condition to remove unwanted data from the data fetched by the data-base adaptor 306 to give filtered data 312. The aggregate operator 314 receives the filtered data 312 as input and replaces certain data with data summaries to give aggregated data 316. For example, aggregate operator 314 may replace selections of data with statistical summaries or sum totals of the selections. The unify operator 318 is input data from the file adaptor 308 and the aggregated data 316, defines the output data schema, and maps fields of the input data to give combined data 320. The unify operator 318 may also take corrective actions, such as setting null values or constants so that each data entry in the input data is mapped to a single record in the combined data 320. The evaluate operator 322 may be used to perform arithmetic, string, or date manipulations on the combined data in order to give aggregated data 324. A view adaptor 326 creates a virtual table from the aggregated data 324.

It should be noted that ITBM systems are not limited to the adaptors and data-management operators described above with reference to FIG. 3. ITBM systems may use any number of a variety different adaptors and data-management operators to generate specific records of data. For example, other types of adaptors that may be used to fetch data for input to data-management operators include, but are not limited to, wildcard-file adaptors, file-upload adaptors, or web-form adaptors, and other data-management operators that may be used in ITBM systems include, but are not limited to, identify, join, correlate, flatten, intersect, rollup, and trend.

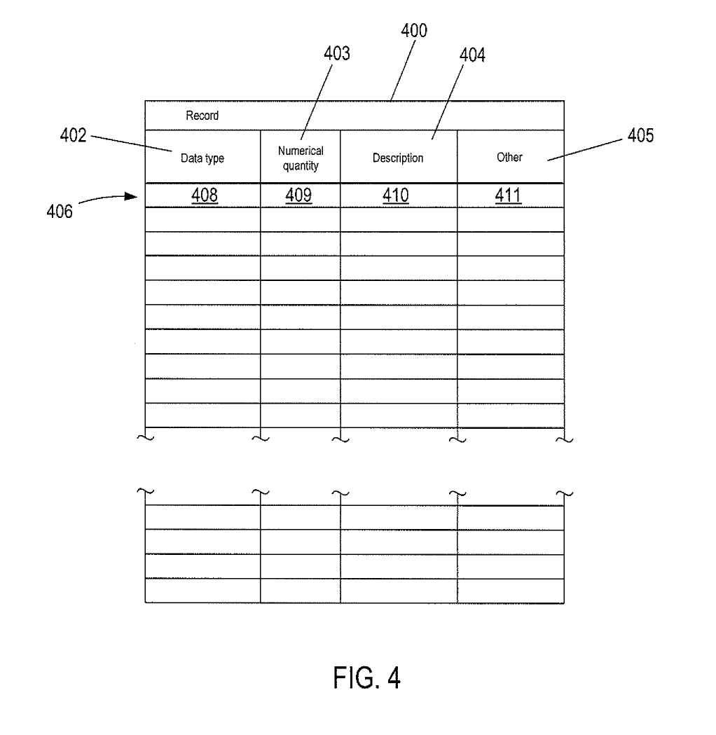

FIG. 4 shows an example format of a record of data 400 that may be created in an adaptor/operator data flow of an ITBM system. The record 400 includes a data type column 402, a numerical value column 403, a description column 404, and a column identified as other 405. Data table entries for data types, numerical quantities, descriptions, and other depends on the kind of data collected, manipulated, and organized to form the record 400. Each row, such as row 406, identifies a specific data type 408, a numerical value 409 associated with the data type 408, a description 410 of the data type 408, and other 411 information regarding the data type identified in entry 408.

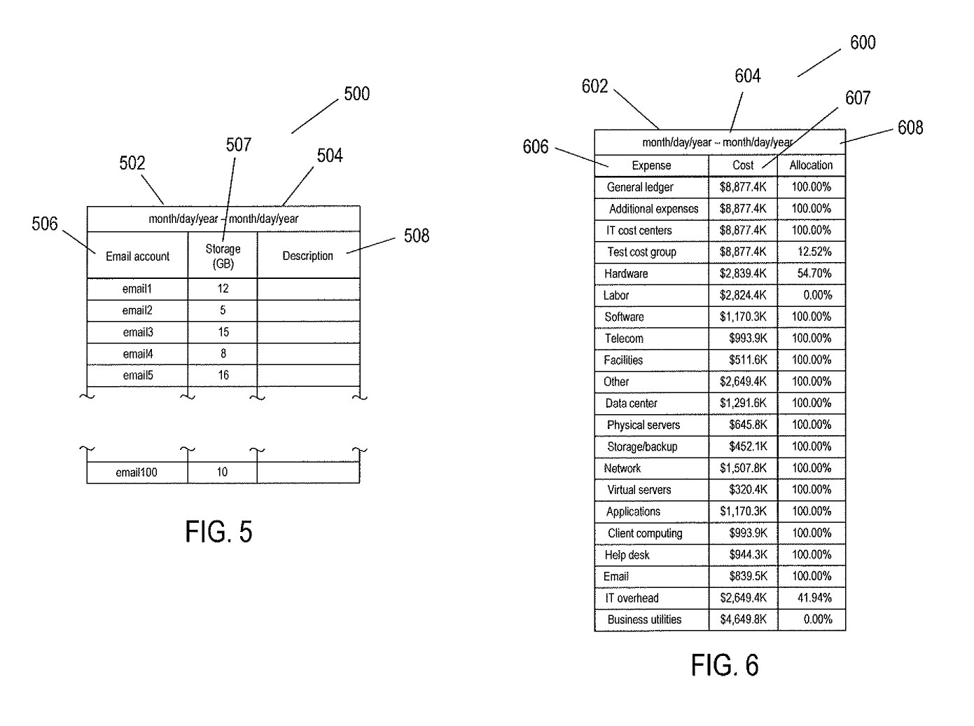

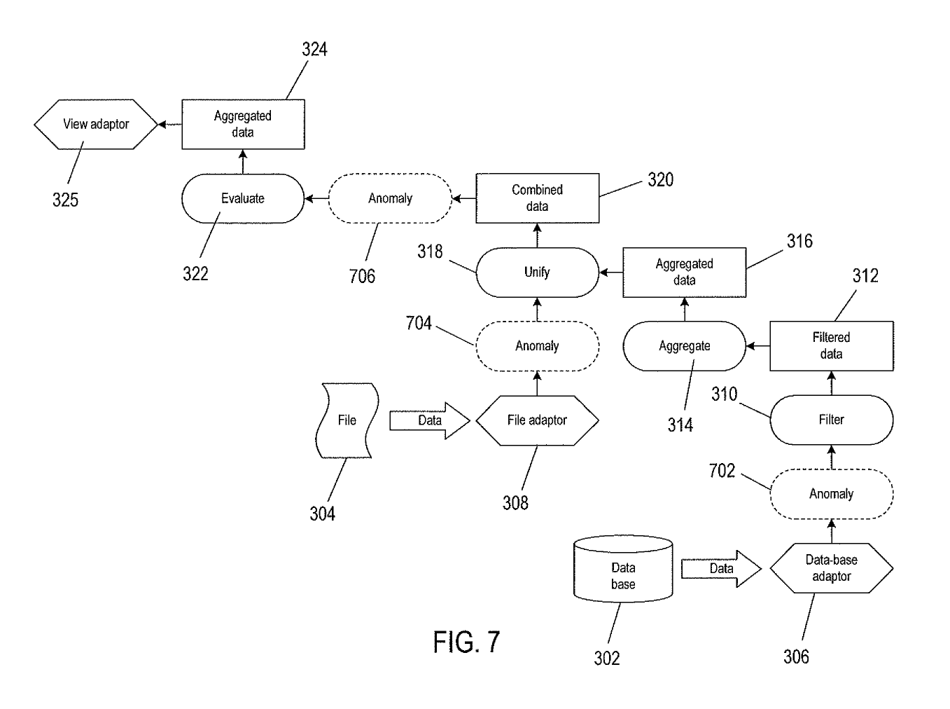

FIGS. 5 and 6 show two example records that may be created by different selections of adaptors and operators of two adaptor/operator flows of an ITBM system. FIG. 5 shows an example of a record of email accounts 500 used by an enterprise. The email record 500 is time stamped with a period beginning date 502 and period ending data 504 that indicates an interval of time over which data storage for each email account is recorded. The interval of time may be a billing cycle or interval of time between billing the enterprise for email storage. In this example, the data types are the email accounts listed in column 506, the numerical quantities listed in column 507 are the amount of storage in GBs. Column 508 is a description column with entries that describe aspects of each email account.

FIG. 6 shows an example of a bill of IT 600 that presents an itemized list of costs of various IT services purchased by an enterprise. The bill of IT 600 is time stamped with a period beginning date 602 and period ending data 604 that indicates the period of time over which the services listed in the bill of IT 600 were used by the enterprise. The interval of time may be a billing cycle or interval of time between billing the enterprise for the services listed in the bill of IT 600. In this particular example, the bill of IT 600 is organized into three separate columns 606-608 correspondingly labeled “Expense,” “Cost,” and “Allocation.” The expenses identified in column 606 are the data types, costs in column 607 are a first list of numerical quantities, and the percentages in column 608 are a second list of numerical quantities.

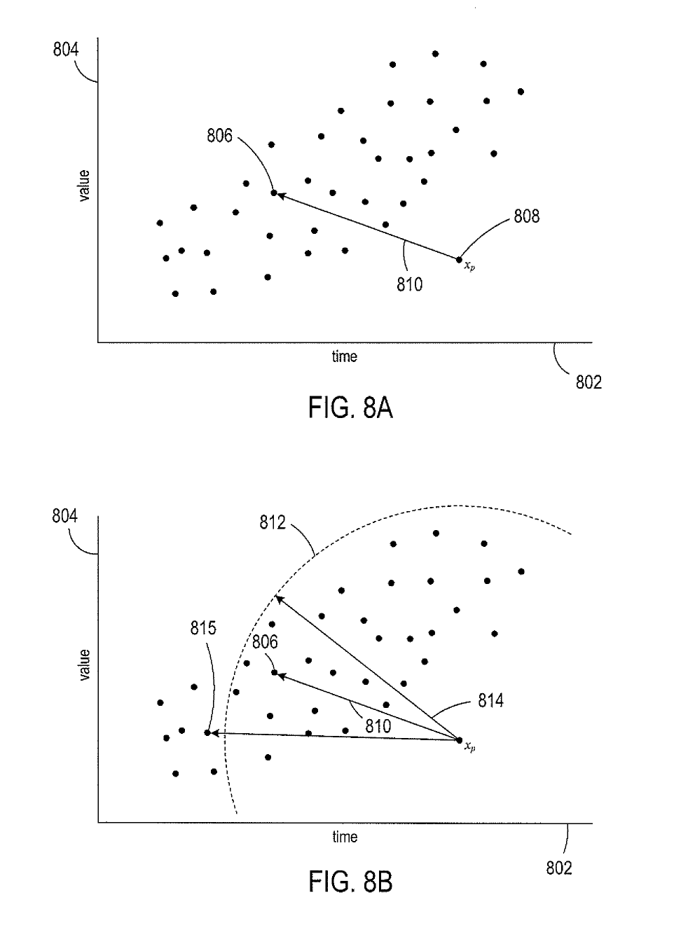

Anomaly operators may be incorporated into an ITBM system in any number of different ways in order to detect anomalous data in records output from adaptors and/or data-management operators. FIG. 7 shows examples of three ways anomaly operators may be incorporated into the example adaptor/operator flow described above with reference to FIG. 3. In a first example, an anomaly operator 702 is inserted between the data-base adaptor 306 and the filter operator 310. In this example, the anomaly operator 702 detects anomalies in the raw data fetched from the data-base adaptor 306. In a second example, an anomaly operator 704 is inserted between the file adaptor 308 and the unify operator 318. In this example, the anomaly operator 704 detects anomalies in the raw data output from the text file adaptor 308. Anomaly operators are not limited to detecting and correcting, or deleting, anomalous data output from adaptors. In other implementations, anomaly operators may be used to detect and correct, or delete, anomalous data in records output from a data-management operator. For example, in a third example, an anomaly operator 706 is inserted between the combined data 320 and the evaluate operator 322. In this example, the anomaly operator 706 is used to detect anomalies in the combined data 320 before the data is input to the evaluate operator 322.

Anomaly operators described below use outlier detection to detect anomalies in the numerical values of a record of data output from an adaptor or a data-management operator. Outlier detection may be applied to the numerical quantities associated with one or more data types. It should be noted that methods may be applied to data collected in a batch of time periods output from an adaptor or a data-management operator. Alternatively, methods may be applied to a data of a current batch of time periods joined with a history data from any number of preceding time periods in order to detect data anomalies over a much larger interval of time and not just in the time periods of a current batch of time periods. For example, a data-base adapter that collects data for a data type on a monthly basis may join the data for the current month with any number of previous months in order to detect anomalies in the context of a larger interval of time. Consider the record in FIG. 5, which list storage for 100 email accounts collected in a single time period. Outlier detection may be used to detect data storage anomalies for any single email account over a number of recent time periods collected by a data-base adaptor. The storage data of the email account for the recent time periods may be joined with storage data for any number of time periods preceding the recent time periods in order to detect data anomalies over a much longer interval of the time than in just the recent time periods.

The following description presents an outlier detection technique for detecting anomalous numerical data associated with one or more data types output from either an adaptor or an operator of an adaptor/operator flow. Consider a set of M points {xᵢ}ᵢ₌₁^{M} associated with one or more data types. The number of points M may represent a number of points output from an adaptor or data-management operator for a number of recent time periods or represent a number of points output from an adaptor or data-management operator of recent time periods joined with a number of points associated with time periods that precede the recent time periods. In certain implementations, xᵢ=(Vᵢ, Tᵢ), where Vᵢ is the numerical value of the date type, Tᵢ may be the time period when the data type is recorded, and M is the number of time periods. For example, for the record of FIG. 6, Vᵢ may represent the cost of the “facilities” expense in a billing cycle Tᵢ over M billing cycles. In order to determine whether a data point xₚ is an outlier of the set {xᵢ}ᵢ₌₁^{M} the method begins by calculating distances from the point xₚ to each of the other points in the set {xᵢ}ᵢ₌₁^{M} in order to obtain a set of distances:

{d(xₚ,xᵢ)}₁₌₁^{M-1} (1)

The k points xᵢ with the k shortest distances in the set of Equation (1) form a set of k-nearest neighboring points to the point xₚ. The set of k-nearest neighbor points is denoted by Nₚ (xₚ ∉Nₚ) and is referred to as the neighborhood of point xₚ. The data type associated with the point xₚ is identified as an anomaly when the point xₚ is outside the neighborhood Nₚ as determined by:

$$d ( {x}_{p} , \overline{x} ) > \frac{k + 1}{k ( k - 1 )} {\sum }_{{x}_{i} ∈ {N}_{p}} d ( {x}_{i} , \overline{x} ) = \frac{{\overline{d}}_{{x}_{p}}}{{\overline{D}}_{{x}_{p}}} \qquad ( 2 )$$

where

$$\overline{x} = \frac{1}{k} {\sum }_{{x}_{i} ∈ {N}_{p}} {x}_{i} \qquad ( 3 a )$$

is the center of the neighborhood Nₚ;

$${\overline{d}}_{{x}_{p}} = \frac{1}{k} {\sum }_{{x}_{i} ∈ {N}_{p}} d ( {x}_{p} , {x}_{i} ) \qquad ( 3 b )$$

is an average of the distance of the point xₚ to each cost the neighborhood Nₚ; and

$${\overline{D}}_{{x}_{p}} = \frac{1}{k ( k - 1 )} {\sum }_{{x}_{i} , {x}_{i ′} ∈ {N}_{p} , i \neq i ′} d ( {x}_{i} , {x}_{i ′} ) \qquad ( 3 c )$$

is an average distance between the points in the neighborhood Nₚ.
In certain implementations, the distance d may be an Euclidean distance denoted by ∥.∥ or the square of the Euclidean distance ∥.∥². In other implementations, the distance d may be simply a function of points. For example, d(xᵢ,xⱼ)=|Vᵢ−Vⱼ| and

$$\overline{V} = \frac{1}{k} {\sum }_{{V}_{i} ∈ {N}_{p}} {V}_{i}$$

### in Equations (1)-(3).

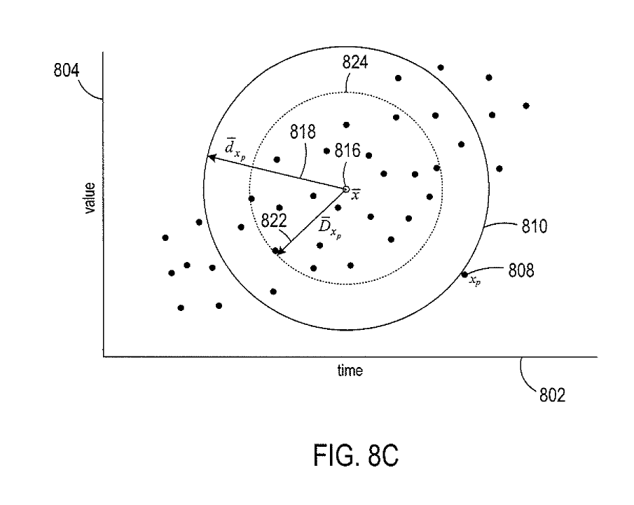

FIGS. 8A-8C illustrate an example of outlier detection for a set of points associated with a particular expense tracked over 38 (i.e., M=38) time periods. In FIGS. 8A-8C, horizontal axis 802 represents time and vertical axis 804 represents cost. Solid dots represent a set of points associated with a particular expense recorded over M time periods. Consider determining whether or not a particular numerical value Vₚ of point x₇, 808 is an outlier. The distance from the point xₚ 808 to each of the other M−1 points in the set are calculated according to Equation (1). For example, directional arrow 810 represents the Euclidean distance from the point xₚ 808 to the point 806. The k points xᵢ with the k shortest distances to the point xₚ 808 are identified to form a neighborhood Nₚ composed of the k-nearest neighbor points to xₚ 808. In FIG. 8B, k equals 30 and dashed curve 812 represents a boundary between points in the neighborhood Nₚ and points in the compliment of the neighborhood Nₚ. Points with the 30 shortest distances to the point xₚ 808 that are less than radial distance 814, such as point 806, are in the neighborhood Nₚ of the point xₚ 808, while points with a radial distance greater than radial distance 814, such as point 815, are in the compliment of the neighborhood Nₚ. In FIG. 8C, a point x̅ 816 identifies the center of the neighborhood Nₚ calculated according to Equation (3a); directional arrow 818 represents the average distance d̅ₓ_{ₚ} between from the point xₚ 808 to points in the neighborhood Nₚ calculated according to Equation (3b), which is illustrated as the radius of a circle 820 centered on the point 816; and directional arrow 818 identifies the average distance D̅ₓ_{ₚ} between points in the neighborhood Nₚ calculated according to Equation (3c), which is illustrated as the radius of a circle 824 centered on the point 816. According to Equation (2), when d(xₚ, x̅> d̅ₓ_{ₚ}/ D̅ₓ_{ₚ}, the point xₚ is be considered an outlier and the data type and numerical value are referred to as data anomalies.

In alternative implementations, a user selected tolerance, denoted by TOL, may be included in order to avoid classifying any value with a point outside the neighborhood Nₚ as an outlier. For example, certain values may be on the outside edge of the neighborhood Nₚ but should not necessarily be considered an outlier. As a result, in alternative implementations, the point xₚ is outside the neighborhood of k-nearest neighbors and the value Vₚ may be identified as an outlier when

$$d ( {x}_{p} , \overline{x} ) > \frac{k + 1}{k ( k - 1 )} {\sum }_{{x}_{i} ∈ {N}_{p}} d ( {x}_{i} , \overline{x} ) + T O L = \frac{{\overline{d}}_{{x}_{p}}}{{\overline{D}}_{{x}_{p}}} + T O L \qquad ( 4 )$$

where TOL is a user selected tolerance.

After the outliers have been identified, the outliers are rank ordered. In certain implementations, the outliers may be rank order according to their distance from the center x̅ of the neighborhood Nₚ with the outlier located farthest away receiving the rank of “1” and the outlier located closest to the center x̅ receiving the rank that corresponds to the total number of outliers. Alternatively, the outlier located closest to the center Se receives the rank of “1” and the outlier located farthest from the center x receives the rank that corresponds to the total number of outliers.

When data types with anomalous values are detected, a user may decide to replace the anomalous numerical values with the mean or median of the numerical values over a number of time periods for the same data type or the user may decide to delete the all data associated with the anomalous value. For example, suppose the numerical value Vₒ for a particular data type has been identified as an outlier as described above with reference to Equations (2) or (4). The user may decide to replace the numerical value Vₒ with the mean of the M numerical values for the same data type calculated according to

$$\overline{V} = {\sum }_{{i = 1}_{i \neq o}}^{M} {V}_{i} \qquad ( 8 )$$

Alternatively, the user may decide to replace the numerical value with the median of the M numerical values:

V̅=median{Vᵢ}ᵢ₌₁^{M} (9)

In other implementations, an anomalous value Vₒ may be replaced by a maximum or minimum of the numerical values with the anomalous value excluded:

$$\begin{matrix}{V}_{max} = max {\{ {V}_{i} \}}_{{i = 1}_{i \neq o}}^{M} & ( 10 ) \\ {V}_{min} = min {\{ {V}_{i} \}}_{{i = 1}_{i \neq o}}^{M} & ( 11 )\end{matrix}$$

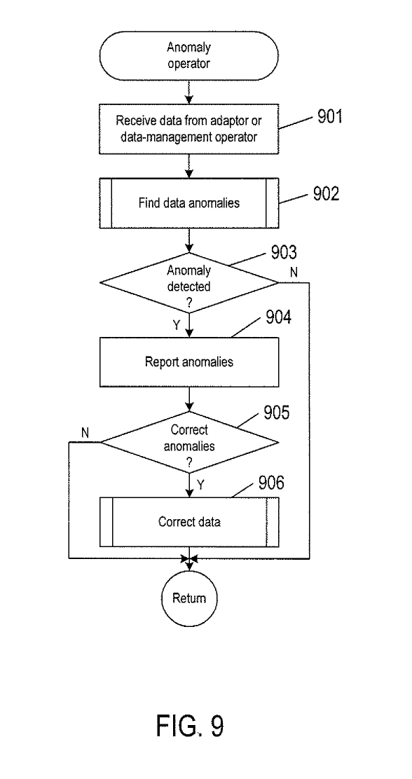

FIG. 9 shows a flow-control diagram of an example anomaly operator. In block 901, data is received from an adaptor or a data-management operator as described above with reference to FIG. 7. In block 902, a routine “find data anomalies” is called to receive the data and detect any data anomalies. In block 903, when data anomalies are detected in the data, control flows to block 904; otherwise, the anomaly operator returns control to the ITBM system. In block 904, the data types and anomalous numerical quantities are reported. For example, returning to the bill of IT in FIG. 6, it may be the case that in one of the billing cycles the cost associated with the expense “facilities” may be much higher or lower than the costs associated with the expense “facilities” for all other billing cycles recorded in the data. The expense “facilities” and the anomalous cost may be reported to a user in a graphic-user interface that displays the expense “facilities” and the anomalous cost in a table along with any other data anomalies detected in block 902. In block 905, when a user decides to correct the anomalies reported in block 904, control flows to block 906. In block 906, a routine “correct data” is called to allow a user to correct or delete the data anomalies from the data.

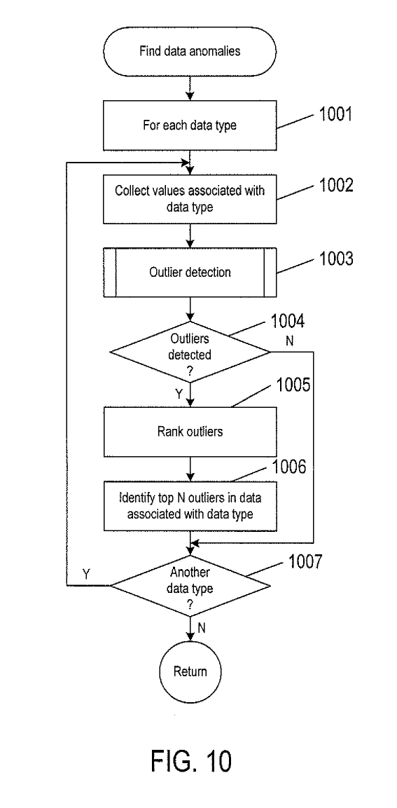

FIG. 10 shows a flow-control diagram of the routine “find data anomalies” called in block 902 of FIG. 9. In block 1001, a for-loop repeats the operations represented by blocks 1002-1007 for each data type identified in the data. In block 1002, M numerical values associated with a data type are collected over a number of time periods, such as billing cycles. In block 1003, a routine “outlier detection” is called to detect an outlier in the numerical values associated with the data type. In block 1004, when one or more outliers are detected control flows to block 1005, otherwise, control flows to block 1007. In block 1005, a routine “rank outliers” is called to rank the outliers. In block 1306, the N highest ranking outliers are identified. In block 1007, when all data types in the data have been checked for outliers over M periods, control flows back the method in FIG. 9, otherwise, the operations in blocks 1002-1006 are repeated.

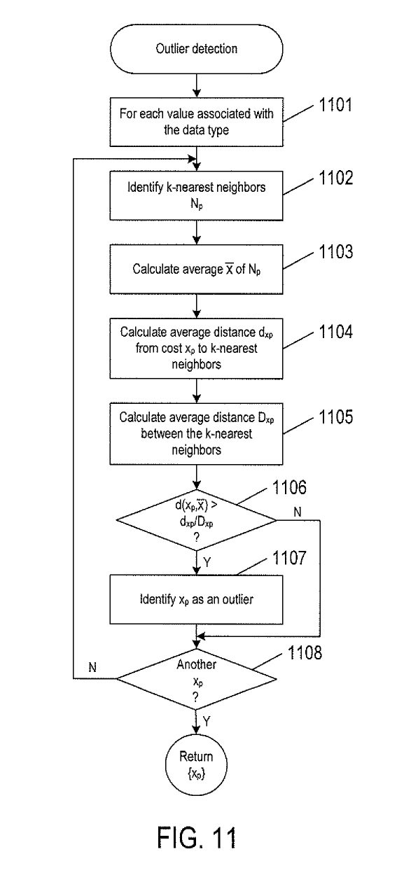

FIG. 11 shows a flow-control diagram for the routine “outlier detection” called in block 1003 of FIG. 10. A for-loop beginning with block 1101 repeats the operations in blocks 1102-1108 for each of M numerical values associated with the data type. In block 1102, k-nearest neighbor points to a point xₚ are identified to form a neighborhood Nₚ described above with reference to FIG. 8A. In block 1103, an average x̅ is calculated for the points in the neighborhood Nₚ, as described above with reference to Equation (3a). In block 1104, an average distance d̅ₓ_{ₚ} from the point xₚ to each point in the neighborhood Nₚ is calculated according to Equation (3b). In block 1105, an average distance D̅ₓ_{ₚ} between the points in the neighborhood are calculated according to Equation (3c). In block 1106, when d(xₚ, x̅) is greater than d̅ₓ_{ₚ}/ D̅ₓ_{ₚ} calculated according to Equation (2), the method proceeds to block 1007. Otherwise, the method proceeds to block 1108. In block 1107, an expense node with d(xₚ, x̅) greater than d̅ₓ_{ₚ}/ D̅ₓ_{ₚ} is identified as an outlier. In block 1108, the operations in blocks 1102-1107 are repeated for another data type. Otherwise, the method returns a set of outliers {xₚ}.

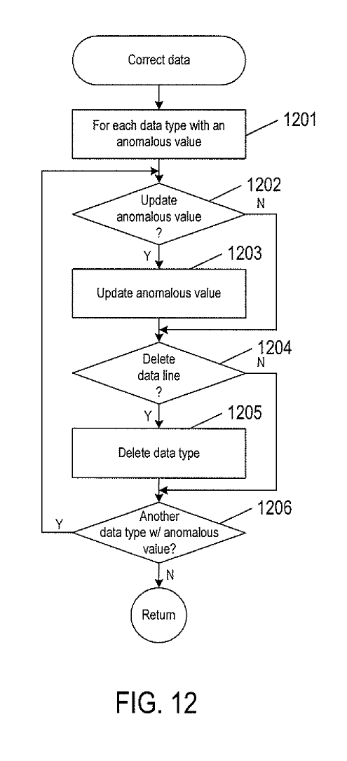

FIG. 12 shows a flow-control diagram for the routine “correct data” called in block 906 of FIG. 9. A for-loop beginning with block 1202 repeats the operations in blocks 1202-1206 for each data type with an anomalous numerical value detected in block 902 of FIG. 9. In block 1202, when a user selects updating the anomalous value, control flows to block 1203. In block 1203, the anomalous value is updated by replacing the anomalous value with the mean, median, maximum or minimum value as described above with reference to Equations (8)-(11). In block 1204, when a user selects delete, control flows to block 1205. In block 1205, data associated with the data type is deleted. In block 1206, when more data types with anomalous numerical values are available, the method repeats the operations in blocks 1201-1205.

Although the above disclosure has been described in terms of particular implementations, it is not intended that the disclosure be limited to these implementations. Modifications within the spirit of the disclosure will be apparent to those skilled in the art. For example, any of a variety of different implementations can be obtained by varying any of many different design and development parameters, including programming language, underlying operating system, modular organization, control structures, data structures, and other such design and development parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system for correcting data anomalies comprising:
one or more processors;
one or more data-storage devices; and
a routine stored in the data-storage devices and executed using the one or more processors, the routine
receiving a record of data output from an adaptor or a data-management operator of an information technology business management system, the record of data including data types and associated numerical values recorded over a number of time periods;
detecting one or more data anomalies in the record of data based on the numerical values of the data types in the time periods;
reporting a set of the one or more data anomalies to a user; and
correcting the data anomalies in the recorded data based a user's decision to selectively correct or delete each of the data anomalies.

2. The system of claim 1, wherein the adaptor or the data-management operator are incorporated in an adaptor/operator flow of the information technology business management system.

3. The system of claim 1, wherein detecting the one or more data anomalies further comprises:
for each data type,
collecting a set of data points over the time periods, each data point represents a numerical value and time period for the data type;
detecting outlier data points in the set of data points based on a distance from each data point to a center of a neighborhood of nearest data points in the set;
when one or more outlier data points are detected, rank ordering the outlier data points; and
identifying a set of highest ranked outlier data points based on the rank order of the one or more outlier data points, the set of highest ranked outlier data points correspond to the set of one or more data anomalies reported to the user.

4. The system of claim 3, wherein detecting outlier data points in the set of data points of the data type further comprises
for each data point,
determining the neighborhood of nearest data points in the set;
calculating the center of the neighborhood;
calculating a sum of average distances from the data point to each data point in the neighbor;
calculating an average distance between data points in the neighborhood; and
identifying the data point as an outlier data point when the distance from the data point to the center of the neighborhood is greater than a ratio of average distance from the data point to each data point in the neighborhood to the average distance between nearest data points.

5. The system of claim 1, wherein correcting the data anomalies further comprises:
for each of the one or more data anomalies, replacing an outlier numerical value with one of the following:
a mean value of the numerical values recorded over the time intervals, excluding the outlier numerical value;
a median value of the numerical values recorded over the time intervals;
a maximum value of the numerical values recorded over the time intervals, excluding the outlier numerical value; and
a minimum value of the numerical values recorded over the time intervals, excluding the outlier numerical value.

6. A method stored in one or more data-storage devices and executed using one or more processors that detects data anomalies, the method comprising:
receiving a record of data output from an adaptor or a data-management operator of an information technology business management system, the record of data including data types and associated numerical values recorded over a number of time periods;
detecting one or more data anomalies in the record of data based on the numerical values of the data types in the time periods;
reporting a set of the one or more data anomalies to a user; and
correcting the data anomalies in the recorded data based a user's decision to selectively correct or delete each of the data anomalies.

7. The method of claim 6, wherein the adaptor or the data-management operator are incorporated in an adaptor/operator flow of the information technology business management system.

8. The method of claim 6, wherein detecting the one or more data anomalies further comprises:
for each data type,
collecting a set of data points over the time periods, each data point represents a numerical value and time period for the data type;
detecting outlier data points in the set of data points based on a distance from each data point to a center of a neighborhood of nearest data points in the set;
when one or more outlier data points are detected, rank ordering the outlier data points; and
identifying a set of highest ranked outlier data points based on the rank order of the one or more outlier data points, the set of highest ranked outlier data points correspond to the set of one or more data anomalies reported to the user.

9. The method of claim 8, wherein detecting outlier data points in the set of data points of the data type further comprises for each data point,
determining the neighborhood of nearest data points in the set;
calculating the center of the neighborhood;
calculating a sum of average distances from the data point to each data point in the neighbor;
calculating an average distance between data points in the neighborhood; and
identifying the data point as an outlier data point when the distance from the data point to the center of the neighborhood is greater than a ratio of average distance from the data point to each data point in the neighborhood to the average distance between nearest data points.

10. The method of claim 6, wherein correcting the data anomalies further comprises:
for each of the one or more data anomalies, replacing an outlier numerical value with one of the following:
a mean value of the numerical values recorded over the time intervals, excluding the outlier numerical value;
a median value of the numerical values recorded over the time intervals;
a maximum value of the numerical values recorded over the time intervals, excluding the outlier numerical value; and
a minimum value of the numerical values recorded over the time intervals, excluding the outlier numerical value.

11. A computer-readable medium encoded with machine-readable instructions that implement a method carried out by one or more processors of a computer system to perform the operations of
receiving a record of data output from an adaptor or a data-management operator of an information technology business management system, the record of data including data types and associated numerical values recorded over a number of time periods;
detecting one or more data anomalies in the record of data based on the numerical values of the data types in the time periods;
reporting a set of the one or more data anomalies to a user; and
correcting the data anomalies in the recorded data based a user's decision to selectively correct or delete each of the data anomalies.

12. The computer-readable medium of claim 11, wherein the adaptor or the data-management operator are incorporated in an adaptor/operator flow of the information technology business management system.

13. The computer-readable medium of claim 11, wherein detecting the one or more data anomalies further comprises:
for each data type,
collecting a set of data points over the time periods, each data point represents a numerical value and time period for the data type;
detecting outlier data points in the set of data points based on a distance from each data point to a center of a neighborhood of nearest data points in the set;
when one or more outlier data points are detected, rank ordering the outlier data points; and
identifying a set of highest ranked outlier data points based on the rank order of the one or more outlier data points, the set of highest ranked outlier data points correspond to the set of one or more data anomalies reported to the user.

14. The computer-readable medium of claim 13, wherein detecting outlier data points in the set of data points of the data type further comprises for each data point,
determining the neighborhood of nearest data points in the set;
calculating the center of the neighborhood;
calculating a sum of average distances from the data point to each data point in the neighbor;
calculating an average distance between data points in the neighborhood; and
identifying the data point as an outlier data point when the distance from the data point to the center of the neighborhood is greater than a ratio of average distance from the data point to each data point in the neighborhood to the average distance between nearest data points.

15. The computer-readable medium of claim 11, wherein correcting the data anomalies further comprises:
for each of the one or more data anomalies, replacing an outlier numerical value with one of the following:
a mean value of the numerical values recorded over the time intervals, excluding the outlier numerical value;
a median value of the numerical values recorded over the time intervals;
a maximum value of the numerical values recorded over the time intervals, excluding the outlier numerical value; and
a minimum value of the numerical values recorded over the time intervals, excluding the outlier numerical value.
